(19) United States
(12) Patent Application Publication
(10) Pub. No.: US 2026/0124590 A1
(43) Pub. Date: May 7, 2026

(54) PLANT AND PROCESS FOR HIGH-EFFICIENCY PRODUCTION OF HYDROGEN BY PYROLYSIS

(71) Applicant: TENOVA S.p.A., MILA (IT)

(72) Inventors: Paolo Argenta, Como (IT); Enrico Malfa, Zanica (IT); Mattia Bissoli, Bovolone (IT); Ronald Victor Manuel Lopez-Gomez, San Nicolas De Los Garza (MX); Petrus Johannes Jonker, Johannesburg (ZA)

(21) Appl. No.: 19/253,395

(22) Filed: Jun. 27, 2025

Related U.S. Application Data
(63) Continuation of application No. PCT/IB2024/050284, filed on Jan. 11, 2024.

(30) Foreign Application Priority Data
Jan. 12, 2023 (IT) 102023000000258

(51) Int. Cl. B01J 6/00; C01B 3/24

(52) U.S. Cl. CPC B01J 6/008; C01B 3/24; C01B 2203/0266; C01B 2203/0833; C01B 2203/085; C01B 2203/0866; C01B 2203/0883; C01B 2203/1241

(57) ABSTRACT

The present invention relates to a plant for high-efficiency production of hydrogen by pyrolysis of an input gas mixture comprising gaseous hydrocarbons, said plant comprising:
a reactor (1) for heating and pyrolyzing said input gas mixture by an electric arc and consequent production of an output produced mixture enriched with hydrogen and containing a solid fraction (Carbon Black and/or carbon in various shapes); and
a heat exchanger (4) for pre-heating said input gas mixture and for cooling said output produced mixture.

The invention also relates to a process for high-efficiency production of hydrogen by pyrolysis

### CROSS-REFERENCE TO RELATED APPLICATIONS

The present application is a Continuation of International Application No. PCT/IB20242/050284, entitled PLANT AND PROCESS FOR HIGH-FREQUENCY PRODUCTION OF HYDROGEN BY PYROLYSIS,” filed Jan. 11, 2024 (docket number 3101-001-04), which is pending at the time of this filing. International Application No. PCT/IB20242/050284 claims priority to Italian patent application number 102023000000258, entitled Impianto e procedimento per la produzione ad elevata efficienza di idrogeno mediante pirolisi, filed Jan. 12, 2023 (docket number 3101-001-IT), which is granted as Italian patent number 782024000166449. To the extent not inconsistent with the disclosure herein, the applications listed above are incorporated by reference in their entirety.

### SUMMARY

The present invention refers to a plant for high efficiency production of hydrogen by pyrolysis. The invention further refers to a process for high efficiency production of hydrogen by pyrolysis.

In more detail, the invention refers to the production of hydrogen by pyrolysis reactions of hydrocarbons. As known, the solutions for producing hydrogen known to the state of the art are divided in categories depending on the basic chemical reaction for obtaining the hydrogen molecule, in particular to which a color is assigned for “disclosing” purposes.

In particular, mention can be made about:
“grey” hydrogen, wherein the production occurs by steam reforming the methane, a technology which involves a significant impact from the point of view of CO₂ emissions;
“blue” hydrogen, wherein steam reforming the methane is operated with capture of CO₂;
“green” hydrogen, wherein the production occurs by electrolysis of water using electric energy produced from renewable sources;
“turquoise” hydrogen, providing a direct pyrolysis of methane (and/or other hydrocarbons).

This latter technology, compared to the others mentioned, requires a lower amount of energy, (up to 7 times less energy-consuming, for example, than the process for producing green hydrogen).

In particular, the production of “turquoise” hydrogen developed recently, substantially with three technologies, and in particular that referred to below as technology A, based on using “bubbles in a molten bath”, technology B, based on using plasma (plasma based) and technology C, based on using a catalytic bed of pellets.

The solution proposed according to the present invention was studied on the basis of technology B, a technology currently employed on an industrial scale at high/very high temperature for producing C₂H₂ (acetylene) and Carbon Black (CB) wherein hydrogen is a by-product.

In particular, employing the B-type technology, based on plasma, commonly uses solutions such as plasma torches, wherein an electric arc is generated through metal electrodes (anode and cathode) normally supplied by direct current and usually cooled through circuits where water circulates.

An alternative for technology B or “plasma technology” consists in using electrodes made of carbon, usually graphite, operating by both direct and alternate current.

In both cases, in order to allow the electric power to be adjusted, cathode and anode are installed along axes inclined with respect to each other, such that, through their moving, moving the ends close and away, and accordingly varying the current, with the same voltage, is possible.

In this technological context, a distinction can be made between:
directheating solutions, wherein methane is generally injected through the torch or in proximity to the plasma arc;
indirect heating solutions, wherein the reactor is made by creating two (or more) areas such as to segregate the electric arc. Therefore, the reactant gas is heated by a second carrier gas which transfers the energy from the arc to methane. This configuration is usually used to maximize the production of CB. The flow exiting the reactor (usually consisting of a mixture of H₂, C₂H₂, and other gases in a lower amount) contains one or more classes of CB. Therefore, the flow is cooled and treated in gas/solid separation systems at high efficiency (scrubber, cyclone, filter). In the case of systems for producing CB, the gaseous current exiting the filtering system, rich in H₂, is usually treated as an effluent, and made inert through a torch before being released in the atmosphere.

However, the known technology B or plasma technology when applied has operative limits, and in particular:
1. obstruction of the torch in the case of injecting methane from the torch itself due to the formation of solid C in proximity to the tip. This defect mainly occurs when using plasma torches or solutions based on injecting the reactant gas through holed electrodes;
2. loss of a part of the energy useful to the reaction in the cooling system (such as for example for the torches cooled by water);
3. difficulty in moving and replacing the electrodes due to the inclination of the latter, in particular for the AC case;
4. difficulty in ensuring the sealing between electrodes and electrode passage openings in the structure of the reactor still due to the inclination of the electrodes, in particular for the AC case;
5. in case of high AC electric powers, which can generate remarkable vibrations in the electrodes, the inclination of the electrodes further accentuates the problems of mechanical resistance (by the way limiting the selection of the electrode typologies to those with higher mechanical resistance, i.e., those made of graphite, which are notoriously more expensive than those made of prebaked carbon and those of the Soderberg type);
6. problems in the procedures of elongating the electrodes, still due to their inclination, which requires additional elements to be installed in the part outside the reactor to compensate the consumption of the electrode;
7. the indirect heating solutions require the use of a carrier gas for transferring energy. In the case where such gas has a composition similar to that of the output gases, it will not be necessary to separate it from the current of products. However, such solution reduces the yield in H₂ of the process and requires having a system for separating the carrier gas from the products;
8. absence or limited recovery of heat from high temperature gases exiting the reactor and consequently low energy efficiency;
9. absence or limited recovery of heat from the high temperature solids (CB) exiting the reactor and consequently low energy efficiency.

With particular reference to points 8. and 9., these limits are of a technical/economical type, as recovering heat from a powder flow (due to the presence of CB) at very high temperature normally involves the need to remove the solid part before the heat exchange (in order to avoid the obstruction of the exchanger). Solutions of this type are very expensive and anyway characterized by limits about maximum temperatures (few hundreds of ° C., up to 800° C.). This results in a limited energy efficiency of the actual process, although the pyrolysis reaction of hydrocarbons is, in terms of pure reaction enthalpy, the most advantageous among those of the state of the art for producing hydrogen.

The main purpose of the present invention is to provide a solution for a process for high efficiency production of hydrogen, in particular turquoise hydrogen, as well as a plant for high efficiency production of hydrogen, and a reactor and a heat exchanger for high efficiency production of hydrogen, capable of solving in a unique combination the above-mentioned problems of the prior art. These results are achieved according to the invention by a plant as described and claimed in the independent claim 1.

The invention further relates to a process for high efficiency production of hydrogen as claimed in claim 16.

### BRIEF DESCRIPTION OF THE DRAWINGS

The present invention will be now described, for illustrative but non-limiting purposes, according to preferred embodiments thereof, with particular reference to the figures of the attached drawings, wherein:

FIG. 1 is a schematic view of the gaseous flows in a plant according to the invention for performing a process according to the invention.

FIG. 2 shows a scheme of the evolution of the temperature of the gas flow in a plant according to the invention;

FIGS. 3a-3d show further evolutions of the gas flow, in particular of its composition;

FIG. 4 shows a sectional view of a first non-limiting embodiment of the inventive reactor which forms part of the plant according to the invention for performing the process according to the invention;

FIGS. 4a-4d are schematic views on orthogonal planes of different possible alternative embodiments of a reactor which forms part of the plant according to the invention for performing the process according to the invention;

FIG. 5 shows a sectional view of a second embodiment of the inventive reactor which forms part of the plant according to the invention for performing the process according to the invention;

FIG. 6 shows a sectional view of a third embodiment of the inventive reactor which forms part of the plant according to the invention for performing the process according to the invention;

FIG. 7 shows a sectional view of a fourth embodiment of the inventive reactor which forms part of the plant according to the invention for performing the process according to the invention;

FIG. 8 schematically shows in a non-limiting manner a first embodiment of the innovative exchanger for the plant according to the invention for performing the process according to the invention;

FIGS. 9, 10 and 11 are respective vertical sectional views of the exchanger in the embodiment of FIG. 8;

FIG. 12 schematically shows an embodiment of the plant according to the invention for performing the process according to the invention; and

FIGS. 13 and 14 schematically show a second embodiment of the innovative exchanger for the plant according to the invention for performing the process according to the invention.

### DETAILED DESCRIPTION

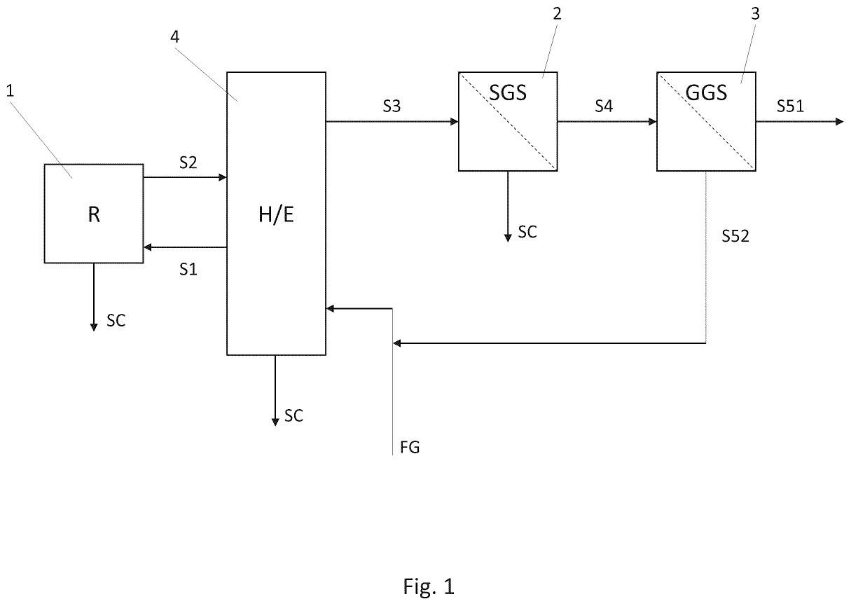

Observing now the figures of the attached drawings, and in particular initially FIG. 1, it should be observed that the plant according to the invention mainly comprises:
a plasma arc reactor 1 (R)
a solid-gas separator 2 (SGS), and a gas-gas separator 3 (GGS)
a heat exchanger 4 (H/E) for pre-heating the input current of methane.

In FIG. 1, as said, a conceptual diagram which represents the gaseous flows in the plant according to the invention is shown.

In particular, there is an entering feed flow “FG” (Feed Gas) of gas or gas mixture, comprising hydrocarbons, for example methane or mixtures of compounds CₓH_{y} in the state of gas or vapor; optionally, the entering gas can be at least partially of non-fossil origin but produced from renewable sources, for example it can be biogas or biomethane. In the following of the disclosure reference will be mainly made to methane, comprising the alternatives set forth above.

The passage through the reactor 1, operating at high temperature (1200-2000° C., preferably 1200-1500° C.) and in substantial absence of oxygen, allows known pyrolysis reactions of the feed gas FG to be made.

As a result of such reactions, there is an output flow of a gas mixture whose composition is enriched with hydrogen H₂; i.e., the hydrogen concentration H₂ in the output gas mixture is greater than the hydrogen concentration H₂ in the entering feed gas FG. In addition to hydrogen H₂, the output flow is composed of acetylene C₂H₂, in addition to gaseous residuals, whose composition substantially depends on the components of the entering gases and on the passage through the reactor 1, and solid residuals, mainly solid-state carbon (in the following “Solid Carbon”, abbreviated to SC) with different crystalline and aggregation forms, comprising the above-mentioned Carbon Black.

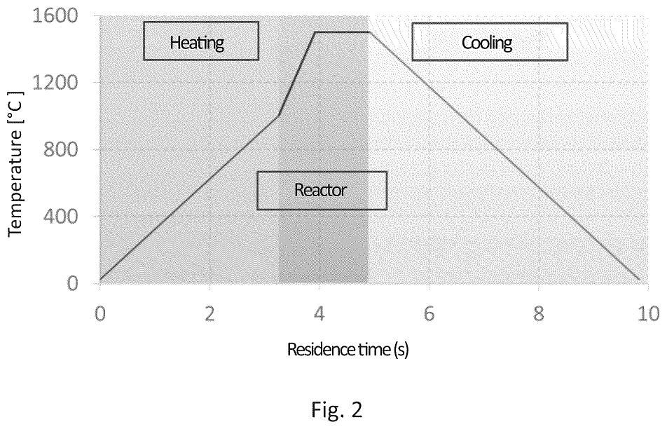

In the process according to the invention, the gas to be processed, in particular methane, is pre-heated in a heat exchanger 4; the flow S1 of pre-heated gas is then sent to the plasma reactor 1, where the pyrolysis reaction occurs. Then, the flow S2 at high temperature of the produced gases (hydrogen, gaseous residuals typically comprising acetylene and methane, in addition to a solid part, consisting of carbon in the form of powder or the like) is passed through the same heat exchanger, cooling itself in favor of the entering methane. Finally, the cooled gaseous flow S3 continues to a gas/solid separator (SGS) for removing the solid part (SC). Successively, the flow S4, depurated of the solid part, is sent to a gas/gas separator (GGS) for removing the residuals of other gases deriving from the pyrolysis reaction (comprising methane and acetylene) and/or originally in the entering gas, obtaining a main flow S51 mainly composed of hydrogen and a residual flow S52, which comprises methane, acetylene and/or other (as described above), which can be optionally recycled by making it converge in the gas flow FG to be processed. In summary, the process according to the invention provides three steps (as illustrated in FIG. 2)
a step of pre-heating the methane current,
a step of reaction, and
a step of cooling the produced gases, now rich in hydrogen.

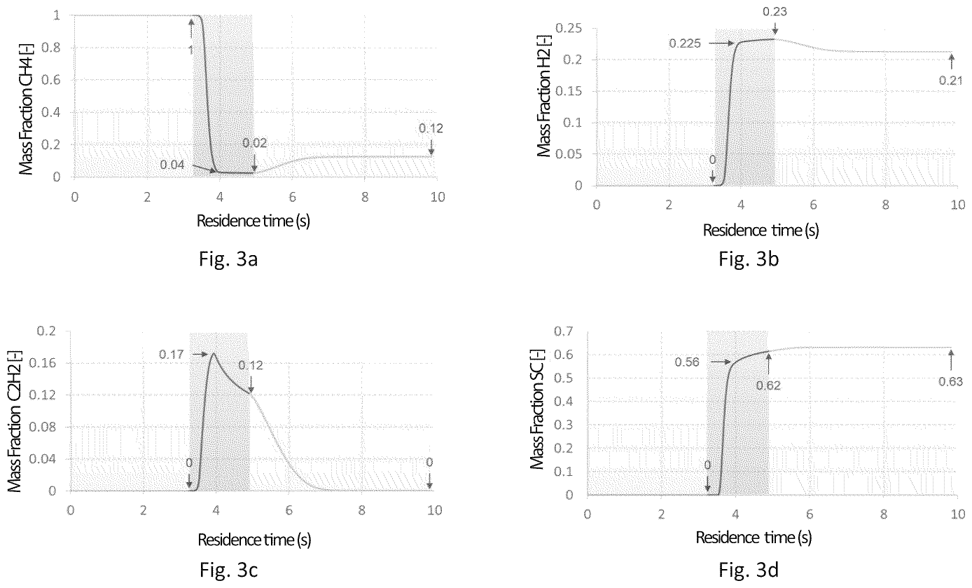

An example of the evolution of the current of the gases is illustrated in the attached FIGS. 3a-3d, showing the trend over time of the mass fraction of certain components (respectively methane CH₄, hydrogen H₂, acetylene C₂H₂, solid carbon in the form of powder or other aggregation forms) of a mass unit of gas subjected to the process according to the invention.

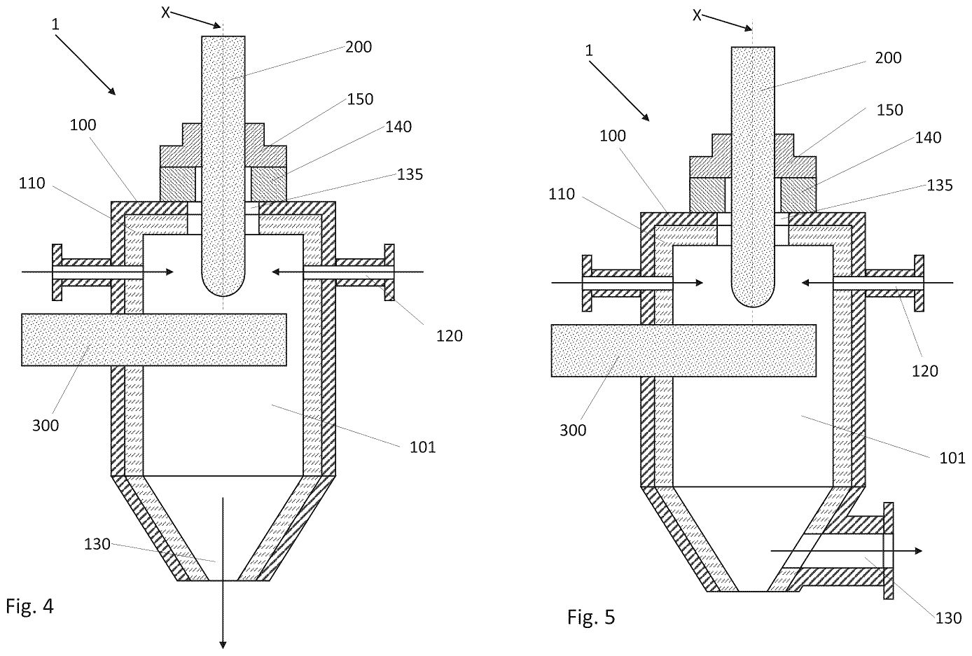

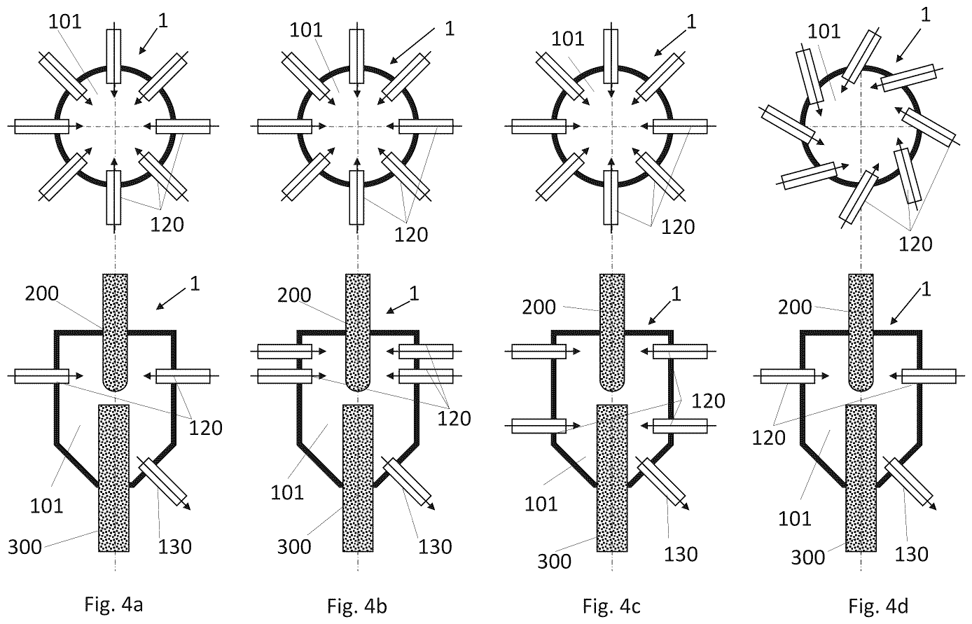

Observing now FIG. 4 of the attached drawings, a first embodiment of the reactor according to the invention, generally denoted by reference number 1, is shown, providing an outer metal structure 100, possibly cooled by water in a known manner, and a heat insulating inner coating 110.

The metal structure 100, together with the inner coating 110, define a reaction chamber 101, inside the reactor 1.

In this embodiment, in the metal structure 100 of the reactor 1 at least one opening 120, connected to a system for feeding the gas to be treated, in this case a gas mixture containing hydrocarbons, in particular methane gas, which allows the gas to be treated to enter the reaction chamber 101, is provided. As schematically shown in FIGS. 4a, 4b, 4c and 4d, the at least one opening 120 can be made in various different manners:
a plurality of injection points directed toward the electrodes, as shown in FIG. 4a;
injection points distributed at different positions along a direction parallel to the axes of the electrodes in order to better distribute the gas, as shown in FIG. 4b (inlets distributed along a single electrode, or on a single side with respect to a plane passing through the area of the arc and perpendicular to the axes of the electrodes) and FIG. 4c (inlets distributed on both sides of a plane passing through the area of the arc and perpendicular to the axes of the electrodes);
injection with tangential arrangement so as to produce a cyclone flow for promoting the separation of CB in the reactor, as shown in FIG. 4d.

The gas flows entering through the opening 120 has a secondary effect of cooling the electrodes, increasing their useful life and their duration. From this point of view, the solution shown in FIG. 4c is particularly advantageous, since it allows a cooling effect on the two sides of the electric arc.

In this embodiment, at least one opening 130 is arranged in the lower part and is vertically facing downward (optionally the opening 130 can be arranged in the upper part, facing laterally or upward), for the leakage of the products of the reaction, comprising a mixture of gas (comprising hydrogen and residuals of hydrocarbons and/or acetylene and possible other gases, as described above) and solid (solid carbon, SC, in the form of powder or other aggregation forms). Said opening 130 is connected to the rest of the plant, not represented in figure, which comprises the systems for treating the products of the reaction (comprising cooling in a dedicated heat exchanger 4, separating the solid carbon in a gas/solid separator 2, and separating the residual methane and acetylene from hydrogen in a gas/gas separator 3).

Furthermore, said structure 100 provides at least one opening 135 for introducing at least one electrode 200. Furthermore, elements for heat insulation 140, elements for pneumatical sealing 150, adapted to prevent gas exchanges between interior and exterior of the reactor at the opening 135 for introducing the electrode 200, in particular intended to prevent air, in particular oxygen, from entering the reactor 1, and the reaction gases within the reactor 1, highly flammable gases also with explosive reactions, from leaking, are provided.

Furthermore, in the reactor 1 there is a fixed electrode 300, for example an anode, electrically connected with the exterior of the reactor.

The mobile electrode 200, in this case a cathode, is vertically arranged and there are means (not represented) for moving the same along its longitudinal axis. Furthermore, preferably, the mobile electrode 200 has a circular and full cylindrical section (i.e., there are no longitudinal holes).

In the reactor 1 according to the invention, the gas flow to be treated (Feed Gas FG, as described above) enters through the passages 120, is heated as a result of the electric arc between anode 300 and cathode 200, until activating the pyrolysis reactions. The gas mixture deriving from the pyrolysis reactions is then extracted through the opening 130 which puts the reactor 1 in communication with the rest of the plant.

In the embodiment illustrated in FIG. 5, the reactor 1 of the plant according to the invention is identical to that illustrated and described with reference to FIG. 4, only differing in that at least one lower opening 130 is facing and addressed horizontally.

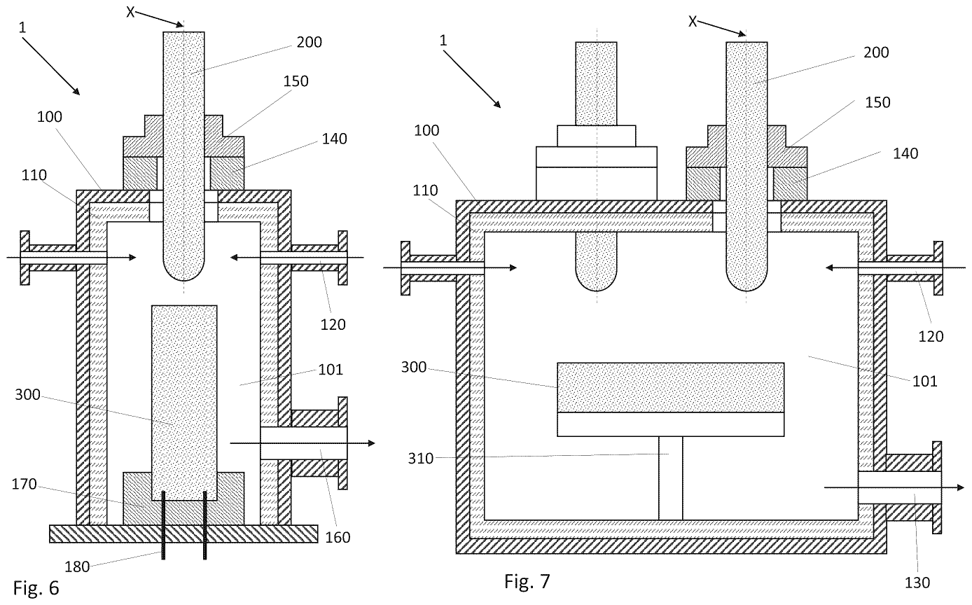

In FIG. 6 of the attached drawings, a third embodiment of the reactor 1 of the plant according to the invention is shown, wherein the fixed electrode 300 (anode) is placed vertically below the mobile electrode 200. Thereby, the gases produced by the pyrolysis reactions are evacuated from the reactor 1 through the opening 160, laterally arranged below on the structure 100, connected to the rest of the plant (not shown).

The anode 300 is supported by a structure 170 made of insulating material and is connected to the electric supply system through one or more connections 180.

A further embodiment of the reactor 1 is schematically represented in FIG. 7, wherein three electrodes 200 (of which one visible in the intersection plane, one represented in partial view, and a third not visible in the figures), which are supplied by a three-phase system, wherein each electrode is connected to one of the three phases of the system.

Furthermore, there is a fixed conductive element 300, which forms, electrically, the star centre of the three-phase system. The fixed conductive element 300, preferably made of carbon, is supported by a supporting structure 310, electrically insulated with respect to the outer metal structure 100.

With this configuration, each electrode 200 can be moved, relative to the fixed element 300, regardless of the other electrodes. This allows to carry out the adjustment of the electric arc, which strikes between each electrode 200 and the fixed conductive element 300, even in the case of electrodes vertically arranged and movable along the vertical direction.

This allows to at least partially solve the technical and maintenance issues described above related to the configurations wherein the electrodes have an inclined arrangement relative to the vertical axis.

The reactor 1 described above with reference to the figures of the attached drawings, which forms an example of reactor to be provided in the plant according to the invention for actuating the process according to the invention, forms a system operating at high temperature (1200-2000° C., preferably 1200-1500° C.) with direct technology, i.e., without a carrier gas for transporting thermal energy, wherein the energy is provided by plasma arc generated by electrodes made of carbon through which direct current (DC) or alternate current (AC) flows.

As illustrated in the figures, the electrodes are vertically positioned and moved along their axis, and can be made of graphite, amorphous carbon or be of the Soderberg type.

When operating both in Direct Current (DC) and in Alternate Current (AC) systems, there is however a fixed conductive element made of carbon in the lower part of the reactor 1.

In the case of Direct Current (DC) systems, it is a fixed electrode, placed vertically below the mobile electrode, such that the electric arc strikes between the two electrodes.

Instead, in the case of operating in Alternate Current AC, the fixed element is electrically configured as a fixed “star centre”, in addition to the three electrodes for the three phases, vertically mobile and independent of each other; the star centre is located in the middle between the three electrodes, therefore the electric arc strikes between each single phase (electrode) and the star centre. It should be observed that in a known electric arc furnace the arcs strike between electrodes and metal bath, the latter representing the “star centre” of the circuit, while in the reactor 1 according to the invention the metal bath is replaced by the fixed conductive element.

Still according to the invention, a system for controlling and moving the electrodes, capable of adjusting the distance between mobile and fixed electrodes (in the DC case) or between the electrodes and the star centre (in the AC case) as a function of the current and voltage parameters adapted to generate an electric arc, is provided.

In order to ensure the operative safety related to the highly explosive/flammable atmosphere, the reactor 1 according to the invention is provided with a sealing system for preventing air/oxygen from entering the reactor, and simultaneously the internal gases (methane, hydrogen, acetylene, etc.) from leaking.

By virtue of the arrangement of the electrodes and their vertical moving, the above-mentioned problems 3) to 6) of the known technology are at least partially solved. The vertical arrangement allows to cancel the bending stress of the electrodes due to their own weight, thus decreasing the mechanical stresses, and making it possible using electrode typologies having lower mechanical resistance and cost. Furthermore, it is also possible to have easier electrode elongating procedures, similar to those used in electric arc furnaces (EAF) and submerged arc furnaces (SAF). Finally making the pneumatic sealing between electrode and passage opening in the reactor structure is simplified.

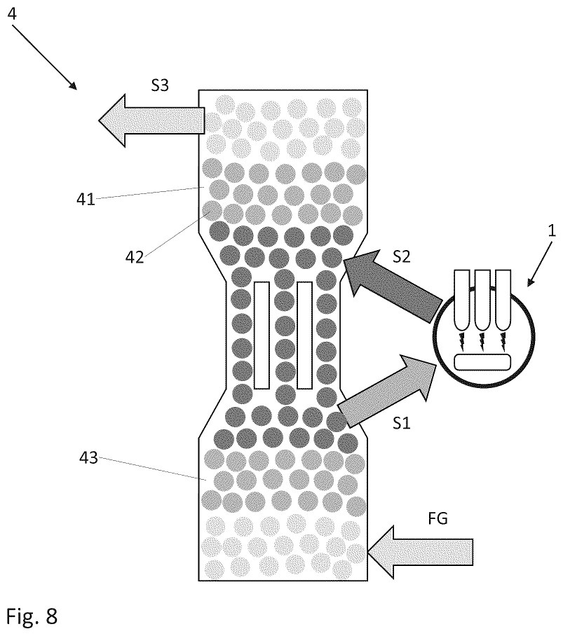

Observing now FIG. 8 of the attached drawings, a heat exchanger, generally denoted by reference number 4, is schematically shown, which forms the heat recovering system, for pre-heating the gas mixture FG (comprising, as described above, gaseous hydrocarbons CₓH_{y}, in particular methane) entering the reactor 1, using the heat of the produced gases.
Said heat exchanger can be made according to two preferred embodiments.

In the first embodiment, schematically represented in FIG. 8 (where lighter greys correspond to lower temperatures, darker greys correspond to higher temperatures), the heat exchanger 4 is of the mobile bed type of typically spherical elements, being divided in two sections: in the first 41 (upper in FIG. 8) the hot gases S2 exiting the reactor 1 transfer heat to spherical elements 42, generating a flow of cooled produced gases S3 exiting the exchanger 4. Said spherical elements 42 are preferably made of hard material, resistant to temperatures higher than 1200/1500/2000° C. (depending on the process temperature, the alumina can be a material usable for the elements 42).

In the entire description, and in particular in this part related to the description of the figures, reference is made to spherical elements 42, but they could be replaced by other solid elements, adapted to form a mobile bed extending in the vertical direction, even if the rounded shapes are preferred, elements which are introduced from above and which descend by gravity downward (the cooled gases are sucked at the exit of the exchanger 4).

In the second part 43 of the exchanger 4 (lower part in FIG. 8) said spherical elements 42, after being heated in the upper part 41, transfer heat to the gas flow FG entering the exchanger 4 and intended to enter the reactor 1 as a flow S1 of pre-heated gas, pre-heating it. The passage between the two parts 41 and 43 is made so as to allow the spherical elements 42 to pass, simultaneously preventing (or however limiting) the gases from passing between the second 43 and the first part 41.

Outside the heat exchanger 4, there is a system (not shown and optional) for recirculating the spherical elements 42 from the second 43 to the first part 41.

Said system, in addition to possibly cool the spherical elements 42, provides a step of cleaning the same, as the hot gases exiting the reactor 1 are rich in SC in suspension, which is partially deposited on said spherical elements 42 and therefore needs to be at least periodically removed therefrom.

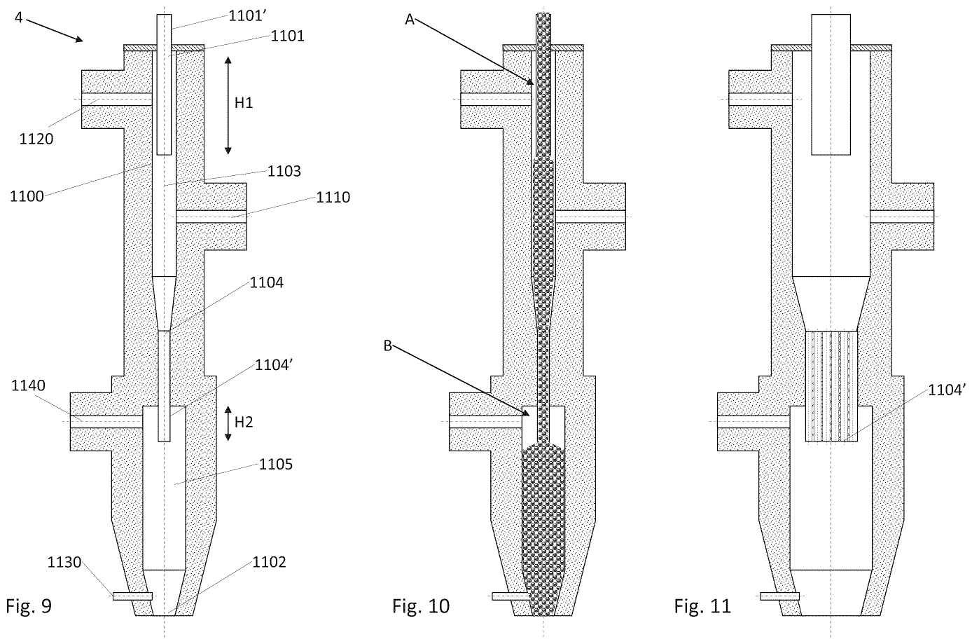

Observing now FIGS. 9, 10 and 11, a first embodiment of the exchanger 4 (mobile bed of spherical elements or of similar shape) consisting of an outer metal structure, internally coated by one or more layers, of which some consisting of refractory material and others of heat-insulating material, is illustrated; the layers can also consist of materials different from each other and can have different differentiated mechanical and thermal features (insulating or refractory). In particular, the used refractory material can be based on alumina. Internally, the exchanger 4 has at least one duct 1100 for passing the spherical elements 42, substantially vertically, comprised between an inlet 1101 and an outlet 1102.

An upper area 1103, an intermediate or transition area 1104, and a lower area 1105 can be identified along the duct 1100.

The input of the spherical elements 42 occurs through at least one duct 1101′, having a lower diameter than the duct 1100, extending through the upper wall of the exchanger 4, within the duct 1100, by a segment having a length H1.

Said upper area 1103 comprises, in addition to the inlet 1101 of the spherical elements 42, at least one inlet 1110 for entering in the upper area the gas flow (e.g., mixture of hydrogen, methane, acetylene, . . . ) coming from the reactor 1. The inlet 1110 can be configurated, as commonly known, for example in a plurality of outlets in the duct 1100 evenly distributed along a cross section of the duct itself, i.e., along the perimetral circumference of the duct at a cross section; a distribution on multiple cross sections, placed at different heights, can be also provided.

The upper area 1103 further comprises at least one outlet 1120 for exiting the gas flow coming from the reactor 1, arranged in the segment (having a length H1) comprised between the bottom end part of the duct 1101′ and the upper wall of the exchanger 4.

The gases passing in the upper area 1103 transfer heat, cooling themselves, to the spherical elements 42 which pass by gravity along the duct 1101′ downwardly.

In addition to the outlet 1102 of the spherical elements 42, the lower area 1105 comprises at least one duct 1104′ for entering the spherical elements coming from the transition area 1104 into the lower area 1105. Said duct 1104′ can have a diameter lower than the duct 1100 and extends through the upper wall of the lower area 1105 by a segment having a length H2.

The lower area 1105 further has at least one inlet 1130 of the gas to be treated intended for the reactor 1, which can be single, as represented in the figures, or can be configured, as known in the art, in a plurality of outlets in the duct 1130 evenly distributed along a cross section of the duct 1100. Furthermore, a distribution on multiple cross sections, placed at different heights, can be also provided.

Furthermore, the lower area 1105 provides at least one outlet 1140 of the gas to be treated directed toward the reactor 1, placed in the segment (having a length H2) comprised between the bottom end part of the duct 1102′ and the upper wall of the lower area 1105 of the exchanger 4.

Thereby, the gas to be treated receives heat, heating itself, from the spherical elements 42 previously heated in the upper area 1103, which thus are cooled in the lower area 1105.

As a function of the process parameters, including the temperature of the spherical elements 42 entering the lower area 1105 and the flow rate of the gas to be treated, the gas to be treated can reach temperatures higher than 400° C.-600° C., thus allowing a partial cracking of the hydrocarbons in the heat exchanger. This allows energy consumptions of the reactor to be reduced. Preferably, but not exclusively, the lower area 1105 can be conformed, in the bottom end area, in an inverted truncated cone shape, as represented in figure.

The transition area 1104 is identified between the connections at a lower height of the upper area 1103 (in figure, the inlet 1110 of the gases exiting the reactor 1) and the upper wall of the lower area 1105. Preferably, but not exclusively, the transition area 1104 has, as represented in figure, a reduced section, with a truncated cone-shaped converging segment having an angle between axis and wall preferably lower than 20°.

Preferably, but not exclusively, the transition area 1104 comprises a plurality of ducts 1104′ connecting the upper area 1103 to the lower area 1105, as schematically represented in FIG. 11.

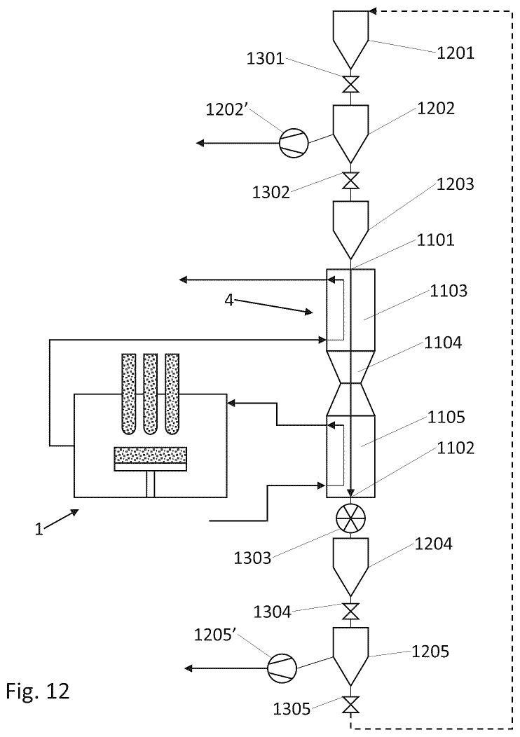

A device 1303 (FIG. 12) for adjusting the flow of spherical elements 42, which can be made for example by a rotative valve of the known type (referred to as valve 1303 below), is provided at the outlet 1102 of the exchanger 4.

The mode of managing the exchanger 4 provides that the entire flow of the spherical elements is only adjusted by the valve 1303, and that there are never free fall segments. The geometry of the inner parts is shaped to keep a mass flow so as to optimize the heat transfer between gases and solids.
In particular:
   the duct 1101′ is constantly filled with spherical elements 42, at least in the segment between the upper wall of the exchanger 4 and the bottom end part of the duct itself.
   the upper area 1103 is constantly filled with spherical elements 42 up to the lower edge of the duct 1101′;
   the transition area 1104, comprising the duct 1104′, is constantly filled;
   the lower area 1105 is constantly filled up to the lower edge of the duct 1104′.

Thereby (in particular observe FIG. 10) at least two areas A and B of plenum are created: plenum A between the outer wall of the duct 1101′ and the corresponding area of the inner wall of the duct 1100; plenum B between the outer wall of the duct 1104′ and the corresponding area of the inner wall of the duct 1100. The output gases are sucked from the two plenums A and B, respectively the gas rich in hydrogen from plenum A and the gas to be treated from plenum B.

Observing now FIG. 12 of the attached drawings, it should be observed that the structure of the heat exchanger 4 according to the invention allows to overcome many drawbacks.

In particular, in the upper area of the exchanger 4 there is a need to ensure that the substantial entirety of the gases in transition in the first chamber (gases which are cooled by the flow of the descending spherical elements 42) exit the exchanger 4 through the duct 1120, and do not leak through the inlet path 1101 of the spherical elements 42 themselves

Furthermore, there is a need to ensure that loading the spherical elements occurs without introducing oxygen or oxidizing mixtures of gas (e.g., air) into the exchanger 4.

In the embodiment illustrated in the attached figures, this object is achieved by a system for loading the spherical elements 42 consisting in sequence from top to bottom as represented in FIG. 12 of:
a first container 1201 of the spherical elements 42, for example a silo or a hopper;
a first sealing valve 1301 (open-close) for passing/blocking the spherical elements 42 and the gases;
a second container 1202 of the spherical elements 42, for example a closed silo, connected with an internal atmosphere control system 1202′ to the silo 1202, with the possibility to make vacuum conditions and/or controlled atmosphere conditions (e.g., inert, or with nitrogen, etc.);
a second sealing valve 1302 (open-close) for passing/blocking the spherical elements 42 and the gases;
a third container 1203 of the spherical elements 42, for example a closed silo, directly connected to the exchanger 4 through the duct 1101′.

With this configuration of the exchanger 4, a method of introducing the spherical elements 42 in the exchanger 4 itself can be performed, comprising the steps of:
1. closing the valve 1301 and loading the container 1201 with an amount not lower than the capacity of the container 1202;
2. when the container 1202 is empty, closing the valve 1302, opening the valve 1301, and filling the container 1202;
3. closing the valve 1301 and making, in the container 1202, controlled atmosphere conditions (vacuum, inert atmosphere, etc.) by the system 1202′;
4. opening the valve 1302 for unloading the contents of the container 1202 within the container 1203, from which the spherical elements 42 flow into the exchanger through the duct 1101′, with continuous flow adjusted by the valve 1303.

Thereby, in the segment below the valve 1302 the presence of a controlled atmosphere and a number of spherical elements 42 adapted to ensure a constant flow rate is always ensured, simultaneously preventing hydrogen from leaking from the duct for introducing the spherical elements 42 and preventing oxygen from entering the heat exchanger:
the containers 1201 and 1203 contain a variable level of spherical elements 42, and are never in conditions of absence of spherical elements 42 in the container 1203;
the container 1202 alternates between a complete filling condition (when it receives the load from the container 1201) and a complete emptying condition (when pouring the load into the container 1203).

There are further possible variants of the above-described sequence and allowing to achieve the same objects.

As can be observed in the figures, in the exchanger 4 there is a transition area 1104 wherein the spherical elements 42 pass from the top chamber 1103 (the spherical elements 42 receive heat from the gas current exiting the reactor 1) to a bottom chamber 1105 (the spherical elements 42 transfer heat by pre-heating the gas to be treated—typically methane—entering the reactor 1).

In such transition area 1104 the passage of the gas to be treated from the bottom chamber to the top chamber needs to be limited, thus maximizing its passage toward the reactor 1.

For this purpose, a suitable hydraulic/fluid-dynamic/fluidic resistance (or, in other words pressure drop) to the passage of the gasses in the transition area 1104 needs to be ensured. Simultaneously, a suitable flow of the spherical elements 42 downwards needs to be ensured, avoiding obstructions in the path of the spherical elements 42 themselves.

This result can be obtained by selecting an average dimension of the spherical elements 42 being suitably small both in an absolute sense and relative to the minimum dimension of the path within the exchanger. Preferably, the average diameter of the spherical elements 42 is lower than 50 mm/25 mm/10 mm/5 mm/1 mm, for example 6 mm, or for example 5 mm.

In order to ensure a suitable flow of the spherical elements 42 without creating obstructions, the minimum diameter of the passage needs to be at least equal to 10 times the average diameter of the spherical elements 42. Another key parameter for making a suitable hydraulic resistance (or pressure drop) to the passage of the gases in the transition area 1104, which needs to be preferably equal to at least 10/20/50/100/200 times the average diameter of the spherical elements 42.

This result can be obtained by selecting an average dimension of the spherical elements 42 being suitably small both in an absolute sense and relative to the minimum dimension of the path within the exchanger. Preferably, the average diameter of the spherical elements 42 is lower than 50 mm/25 mm/10 mm/5 mm/1 mm, for example 6 mm, or for example 5 mm.

In order to ensure a suitable flow of the spherical elements 42, without creating obstructions, the minimum diameter of the passage needs to be at least equal to 10 times the average diameter of the spherical elements 42. Another key parameter for making a suitable hydraulic resistance (or pressure drop) to the passage of the gases is the length of the transition area 1104, which needs to be preferably equal to at least 10/20/50/100/200 times the average diameter of the spherical elements 42.

Finally, in the top chamber 1103 of the exchanger 4, the spherical elements 42, in addition to receiving heat from the gas current exiting the reactor 1, store on their surface at least a part of the SC in suspension in the current itself. Successively, in the bottom chamber 1105, the spherical elements 42 transfer heat to the gas to be treated, pre-heating it, and passing from a temperature in the order of 1200/1500/2000° C. at the inlet of the bottom chamber to another in the order of 100-400° C. at the end of the step of heat exchanging with the gases to be treated directed to the reactor. At the end of this path, therefore, there are spherical elements 42 which are covered by a layer of SC, and which are at a high temperature. In these conditions, if exposed to an oxidizing agent (e.g., air), there would be a remarkable risk of fire of the SC.

In order to avoid this risk, means for a controlled transition, in terms of composition and temperature, toward an oxidizing atmosphere such as air are provided downstream of the valve 1303 for adjusting the flow of spherical elements 42. Such means can be composed of a system conceptually similar to what is described for loading the spherical elements 42 entering the exchanger, and comprising:
a first container 1204 which is always receiving the flow of spherical elements 42 from the valve 1303;
a first sealing valve 1304 (open-close) for passing/blocking the spherical elements 42 and the gases;
a second container 1205, provided with an internal atmosphere control system 1205′, and receiving the load of spherical elements 42 from the first container 1204;
a second sealing valve 1305 (open-close) for passing/blocking the spherical elements 42 and the gases.

With this configuration, a method of evacuating the spherical elements 42 in the exchanger can be performed, comprising the steps of:
1. closing the valve 1304 and loading the container 1204 with an amount not lower than the capacity of the container 1205;
2. closing the valve 1305, opening the valve 1304, and filling the container 1205;
3. closing the valve 1304 and making, in the container 1205, controlled atmosphere conditions (vacuum, inert atmosphere, etc.) by the system 1205′; note: this step preferably comprises cooling the spherical elements 42 in the container 1205, which can be performed for example by a cooled current of insert gas;
4. opening the valve 1305 for unloading the contents of the container 1205;
5. closing the valve 1305 and restoring a controlled atmosphere within the container 1205.

Thereby, in the segment above the valve 1304 the presence of a controlled atmosphere and an available volume adapted to receive the constant flow rate coming from the valve 1303 is ensured at any moment, simultaneously preventing air from entering the exchanger. Furthermore, it should be highlighted that in this process:
the container 1204 contains a variable level of spherical elements 42;
the container 1205 alternates between a complete filling condition (when it receives the load from the container 1204) and a complete emptying condition (when pouring the load through the valve 1305).

Thereby, the spherical elements 42 can be effectively unloaded from the exchanger 4 at a safe temperature for preventing the SC from burning in air in a uncontrolled manner.

There are other sequences allowing to obtain the same result, for example, it is possible to start with the valve 1304 being open and the valve 1305 being closed. When the container 1205 is filled, closing the valve 1304, and starting the gas managing procedure for making the material in the container 1205 inert. At the end, opening the valve 1305 for unloading the container 1205. Then, closing the valve 1305 and making the container 1205 inert. At this point, the system is ready to reiterate the cycle.

Downstream of the valve 1305, a storage in air of the spherical elements 42 for their subsequent use in the exchanger 4 can be provided, after a suitable step of cleaning from residuals of SC.

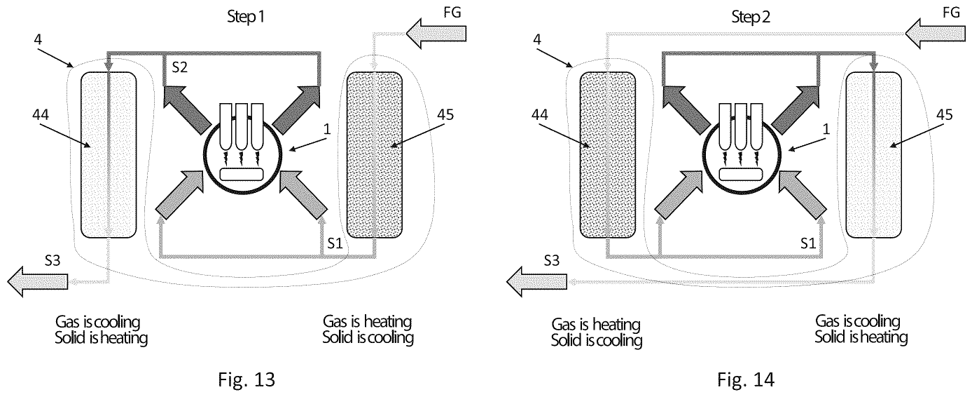

Furthermore, means for recirculating in controlled atmosphere the spherical elements 42 from the outlet to the inlet of the exchanger 4, which can comprise cooling, cleaning from SC, and recovering it, can be provided. In a second embodiment thereof, the exchanger 4 can have a fixed bed structure (observe FIGS. 13 and 14), consisting of at least two units 44 and 45, which work in an alternate configuration.

In this embodiment, the heat exchange means within the units 44 and 45 can be based on solids with different shapes and compositions such as for example spheres, saddles, foams, rings, honeycombs, etc., and made of ceramic material, metal material, metal oxides (for example DRI).

For example, the exchange means consists of ceramic spheres based on alumina resistant to high temperature (>1200° C.) having a diameter comprised between 1 and 100 mm.

In general, within the units 44 and 45, there is a static mass, permeable to the passage of the gases, capable of exchanging heat with the passing gases.

In a first step (FIG. 13), the flow S2 of gases produced by the reactor 1, at high temperature, is passed through the unit 44, which undergoes heating, thus obtaining a flow S3 of cooled gases; simultaneously, the flow FG of the gas to be treated is passed through the unit 45, which has been previously heated at high temperature and which transfers heat, cooling itself, to the passing gas, which exits as a flow S1 of pre-heated gas to be treated and which is sent to the reactor 1 for the pyrolysis.

In a second step (FIG. 14), the flow S2 of gases produced by the reactor 1, at high temperature, is deviated toward the unit 45, which now undergoes heating, thus obtaining a flow S3 of cooled gases; simultaneously, the flow FG of the gas to be treated is now passed through the unit 44, which has been heated at high temperature during the first step and which now transfers heat, cooling itself, to the passing gas, which exits as a flow S1 of pre-heated gas to be treated and which is sent to the reactor 1 for the pyrolysis.

From the description set forth above, it is clear and apparent to those skilled in the art that the described configurations of the exchanger 4, although particularly suitable to be coupled to the reactor 1 illustrated in the different embodiments thereof, can be effectively used also in conjunction with other typologies of reactors for producing hydrogen by pyrolysis at high temperature, such as for example plasma arc reactors with fixed and/or however oriented electrodes, in particular, but not exclusively, reactors comprising plasma torches. The present invention also relates to a plant for high efficiency production of hydrogen by pyrolysis of an input gas mixture comprising gaseous hydrocarbons, wherein the plant comprises:
a reactor for heating and pyrolyzing an input gas mixture by an electric arc and consequently producing an output produced mixture in which the hydrogen concentration is greater than the hydrogen concentration in the input gas mixture, and containing a solid fraction comprising carbon;
   a heat exchanger 4 for pre-heating the input gas mixture and for cooling the output produced mixture; wherein furthermore the heat exchanger 4 provides one or more heat exchange and storage elements 42, 44, 45, said heat exchange and storage elements 42, 44, 45 store heat by cooling the produced mixture exiting the reactor 1 and successively or simultaneously transfer heat by pre-heating the gas mixture entering the reactor 1. Advantageously, the heat exchange and storage elements 42 consist of a plurality of elements of similar shape to each other, and the exchanger 4 comprises:
      a first chamber 1103, providing at least one upper inlet 1101, placed in the top of the same, for entering the heat exchange and storage elements 42 in the exchanger 4,
   at least one inlet 1110 in communication with the outlet from the reactor 1 of the mixture produced in the reactor 1, such that the mixture transfers heat, cooling itself, to the heat exchange and storage elements 42,
   at least one outlet 1120 toward the reactor 1 of the gas mixture, at a temperature lower than that of inlet,
   the first chamber 1103 of the exchanger 4 being in communication with a second chamber 1105, placed at a vertical height lower than the first chamber 1103, comprising in turn
   at least one upper inlet for the heat exchange and storage elements 42 coming, being hot, from the first chamber 1103,
      at least one inlet 1130 fir the inlet of the gas mixture to be processed, such that the heat exchange and storage elements 42 transfer heat to the input gas mixture, heating it,
      at least one outlet 140 of the input gas mixture in communication with the inlet of the reactor 1,
      at least one bottom outlet 1102 of the second chamber 1105, for exiting the heat exchange and storage elements 42 from the exchanger 4,
   wherein the heat exchange and storage elements 42 pass by gravity from the first chamber 1103 to the second chamber 1105.

Advantageously, the heat exchange and storage elements 42 consist of at least a first and a second arrays 44, 45, permeable to the passage of the gases entering and exiting the reactor 1, wherein in a first step the gases exiting the reactor 1 pass through the first array 44, heating it, and the entering gases pass through the second array 45, heating themselves, and in a second step the two gas flows are inverted, therefore the gas flows exiting the reactor 1 pass through the second array 45, heating it, and the entering gases pass through the first array 44, heating themselves.

As can be understood from the preceding description, the arrangement of the electrodes with a substantially vertical orientation and the possibility of a punctual and accurate power adjustment thereof through said system for moving the electrodes themselves allows to obtain a very advantageous reactor 1 capable of solving the specific problems of the prior art. Furthermore, thereby, in the reactor 1 there is a remarkable easiness and flexibility in changing the electrode, and a simplification of the sealing system of the reactor for preventing oxygen infiltrations.

Furthermore, with the solution according to the invention, a maximization of the yield of hydrogen, an injection of the gas, in particular methane in an area at an even and controlled temperature, and an easy recycle of the non-converted gases are obtained. Furthermore, according to the invention, the possibility to partially separate the solid carbon within the reactor 1 itself is achieved.

Finally, with the solution according to the present invention the heat recovery from the high temperature gases and the consumption reduction are obtained.

The solution according to the present invention further allows the system integration of the reactor of pyrolysis by recovering heat from the exiting hot products (gas and solids) and pre-heating entering gas.

This system integration allows to obtain a particularly high efficiency, due to the possibility to recover heat not only from the gases, but also, at least partially, from the solid carbon, through the particular structure of the reactor and the exchanger, and to effectively use such heat for pre-heating the entering gas.

The present invention has been described, for illustrative but non-limiting purposes, according to preferred embodiments thereof, but it should be intended that variations and/or modifications can be made by those skilled in the art without departing from the related scope of protection as defined in the attached claims.

What is claimed is:

1.-16. (canceled)

17. A system for the production at high efficiency of hydrogen by pyrolysis of an input gas mixture comprising gaseous hydrocarbons, the system comprising:
a reactor for heating and pyrolyzing the input gas mixture by an electric arc and consequent production of an output produced mixture in which the hydrogen concentration is greater than the hydrogen concentration in the input gas mixture, and containing a solid fraction comprising carbon; the reactor including:
a containment structure defining a reaction chamber, provided with controllable openings for the input of the input gas mixture, for the output of the produced mixture;
at least one electrode, disposed through one or more holes in the containment structure, and sealing elements between the holes and the at least one electrode for preventing gas exchange between interior and exterior of the containment structure, and
at least one electrically conductive element placed at least partially within the reaction chamber,
wherein the at least one electrode is movable, relative to other electrodes or to the electrically conductive element, along its axis, and
wherein the electric arc is formed between the one or more electrodes and the at least one electrically conductive element; and
a heat exchanger configured to pre-heat the input gas mixture and cool the output produced mixture, wherein
the heat exchanger provides one or more heat exchange and storage elements, and
the heat exchange and storage elements store heat by cooling the produced mixture exiting the reactor and successively or simultaneously transfer heat by pre-heating the gas mixture entering the reactor.

18. The system according to claim 17, wherein the input gas mixture comprises gases produced from renewable sources.

19. The system according to claim 17, wherein the at least one electrode is arranged with a substantially vertical axis.

20. The system according to claim 17, wherein the electrically conductive element is fixed relative to the containment structure.

21. The system according to claim 17, wherein the electrically conductive element is entirely within the reaction chamber.

22. The system according to claim 17, further comprising:
a solid-gas separator configured to remove solid and powder components from the output produced mixture; and
a gas-gas separator for dividing the output produced mixture, being free from solid components, in a mixture further enriched with hydrogen and a mixture mainly composed of other residual gases.

23. The system according to claim 17, wherein the heat exchange and storage elements include a plurality of elements of similar shape to each other, the heat exchanger comprising:
a first chamber, including:
at least one upper inlet, placed in the top of the first chamber and configured for introduction of the heat exchange and storage elements into the heat exchanger,
at least one first-chamber inlet in fluid communication with the reactor and configured to receive the output produced mixture from the reactor such that heat of the output produced mixture is transferred to the heat exchange and storage elements,
at least one first-chamber outlet configured to output the cooled output produced mixture at a temperature lower than the temperature of the output produced mixture received from the reactor at the at least one first-chamber inlet; and
a second chamber of the heat exchanger, in fluid connection with the first chamber of the heat exchanger and disposed at a vertical height lower than the first chamber, the second chamber including:
at least one upper inlet configured to receive the heat exchange and storage elements, being hot, from the first chamber, wherein the heat exchange and storage elements pass by gravity from the first chamber to the second chamber
at least one second-chamber inlet configured to receive the input gas mixture to be processed, such that the heat exchange and storage elements in the second chamber transfer heat to the input gas mixture,
at least one second-chamber outlet in fluid communication with and configured to output the heated input gas mixture to an inlet of the reactor, and
at least one bottom outlet of the second chamber, configured for release of the heat exchange and storage elements from the heat exchanger.

24. The system according to claim 23, wherein the heat exchanger comprises a transition area between the first and the second chambers, the transition area having a passage section, for passage of the heat exchange and storage elements from the first chamber to the second chamber.

25. The system according to claim 24, wherein the transition area has a transverse dimension at least equal to about 10 times an average dimension of the heat exchange and storage elements, and a length in the direction of the motion of the heat exchange and storage elements at least equal to about 20 times the average dimension of the elements.

26. The system according to claim 24 wherein the heat exchanger comprises a first seal disposed at the upper inlet of the first chamber and a second seal disposed at the bottom outlet of the second chamber, the first and second seals configured to selectively permit traversal of the heat exchange and storage elements into the first chamber and out of the second chamber and to prevent fluids, including gases, from entering and exiting the heat exchanger.

27. The system according to claim 26, wherein the heat exchanger comprises, downstream of the bottom outlet of the second chamber, a flow control mechanism configured to control and adjust flow of the exchange and storage elements from the bottom outlet.

28. The system according to claim 27, wherein the flow control mechanism adjusts the flow of the heat exchange and storage elements through the heat exchanger such that the first chamber, transition area and second chamber of the heat exchanger are always substantially filled with the heat exchange and storage elements such that the heat exchange and storage elements never free-flow uncontrolled within the heat exchanger.

29. The system according to claim 28, further comprising:
a first container configured to hold the heat exchange and storage elements;
a first sealing valve configured to open and close for respectively passing and blocking flow of the heat exchange and storage elements from an outlet of the first container and to block flow of gases therethrough;
a second container configured to receive the heat exchange and storage elements from the first container via the first sealing valve, the second container having an environmental control system configured to control at least one of temperature, pressure, and constitution of the interior environment of the second container;
a second sealing valve configured to open and close for respectively passing and blocking flow of the heat exchange and storage elements from an outlet of the second container and to block flow of gases therethrough;
a third container configured to receive the heat exchange and storage elements from the second container via the second sealing valve, closed, and having an outlet of the third container directly connected to the at least one upper inlet of the first chamber of the heat exchanger.

30. The system according to claim 28, further comprising
a first container configured and disposed to receive the flow of heat exchange and storage elements from the second chamber via the flow control mechanism;
a first sealing valve configured to open and close for respectively passing and blocking flow of the heat exchange and storage elements from the first container and to block flow of gases therethrough;
a second container, configured and disposed to receive a load of the heat exchange and storage elements from the first container, the second container having an environmental control system configured to control at least one of temperature, pressure, and constitution of the interior environment of the second container;
a second sealing valve configured to open and close for respectively passing and blocking flow of the heat exchange and storage elements from the second container and to block flow of gases therethrough.

31. The system according to claim 17, wherein the heat exchange and storage elements comprise at least a first array and a second array, permeable to the passage of the gases entering or exiting the reactor, wherein
in a first step, the output produced mixture exiting the reactor pass through the first array, heating the heat exchange and storage elements of the first array, and the input gas mixture passes through the second array, heating the input gas mixture, and
in a second step the gas flows are inverted, such that the output produced mixture exiting the reactor passes through the second array, heating the heat exchange and storage elements of the second array, and the input gas mixture passes through the first array, heating the input gas mixture.

32. A method for high-efficiency production of hydrogen by pyrolysis of a gas mixture comprising gaseous hydrocarbons, the process comprising:
pre-heating the gas mixture, by causing the gas mixture to contact one or more previously heated heat storage elements, thereby cooling the one or more heat storage elements,
further heating the gas mixture by an electric arc to effect pyrolysis of the gas mixture thereby increasing the hydrogen concentration to produce an output gas mixture;
cooling the output gas mixture by causing the output gas mixture to contact the cooled one or more heat storage elements thereby producing the previously heated one or more heat storage elements.
